(19) United States
(12) Patent Application Publication
(10) Pub. No.: US 2006/0086136 A1
(43) Pub. Date: Apr. 27, 2006

(54) Refrigerator with carbonated water distributor

(76) Inventors: Marco Maritan, Viggiu (IT); Stefano Tavolazzi, Verbania-Intra (IT)

Correspondence Address: WHIRLPOOL PATENTS COMPANY - MD 0750, 500 RENAISSANCE DRIVE - SUITE 102, ST. JOSEPH, MI, 49085, US

(21) Appl. No.: 10/516,467

(22) PCT Filed: Apr. 10, 2003
(86) PCT No.: PCT/EP03/03723

§ 371 Date: Oct. 24, 2005

(30) Foreign Application Priority Data
May 16, 2002 (IT) MI2002A0001045

(51) Int. Cl. B67D 5/62

(52) U.S. Cl. 62/389; 222/146.6; 261/DIG. 7

(57) ABSTRACT

A refrigerator incorporating in its door a water dispenser within a compartment present on the outside of the door, the dispenser being connected to a water container of given capacity carried by the door and provided to enable the contained water to be carbonated via a connection to a cylinder contains the carbonating gas and is also disposed in the door.

The present invention relates to a refrigerator incorporating in its door a water dispenser, the water being withdrawn by the user at a compartment present on the outside of the door.

In traditional refrigerators of the aforesaid type, there is no provision for dispensing carbonated water in addition to still water.

The main object to he present invention is to provide a refrigerator of the aforestated type which enables both carbonated water and still water to be dispensed.

Another object of the present invention is to provide a refrigerator of the specified type which enables a given quantity of water to be carbonated in situ, i.e. within the door itself.

A further object of the present invention is to provide a refrigerator of the indicated type in which the water can be carbonated by technical means and expedients which are simple and hence economical even though reliable.

These objects and advantages, in addition to others which will be apparent from the ensuing detailed description, are attained by a refrigerator according to the technical teachings of the accompanying claims.

The invention will be more apparent from the following detailed description of a preferred embodiment thereof provided by way of non-limiting example and illustrated in the accompanying drawings, in which:

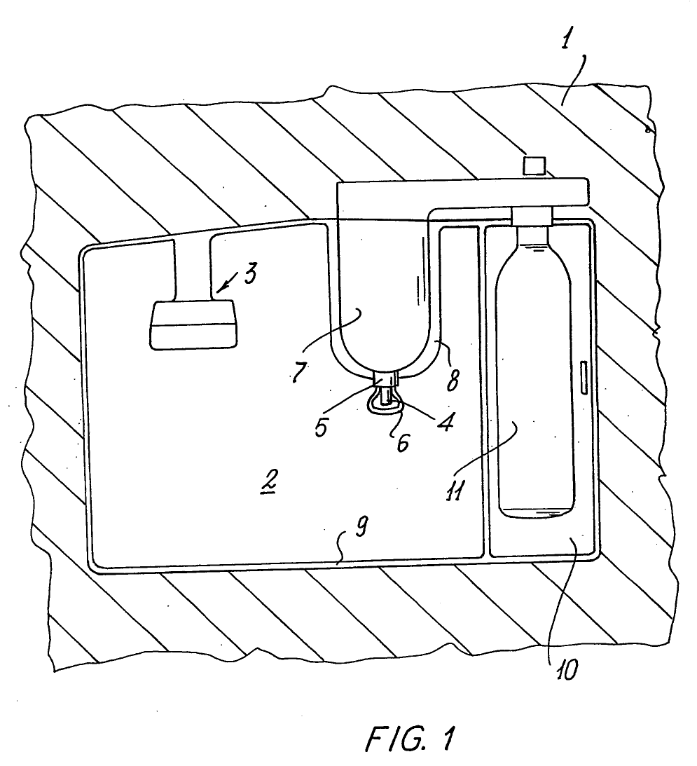

FIG. 1 is a schematic partial view of a refrigerator door shown in vertical section through the compartment from which the water present in the door is withdrawn.

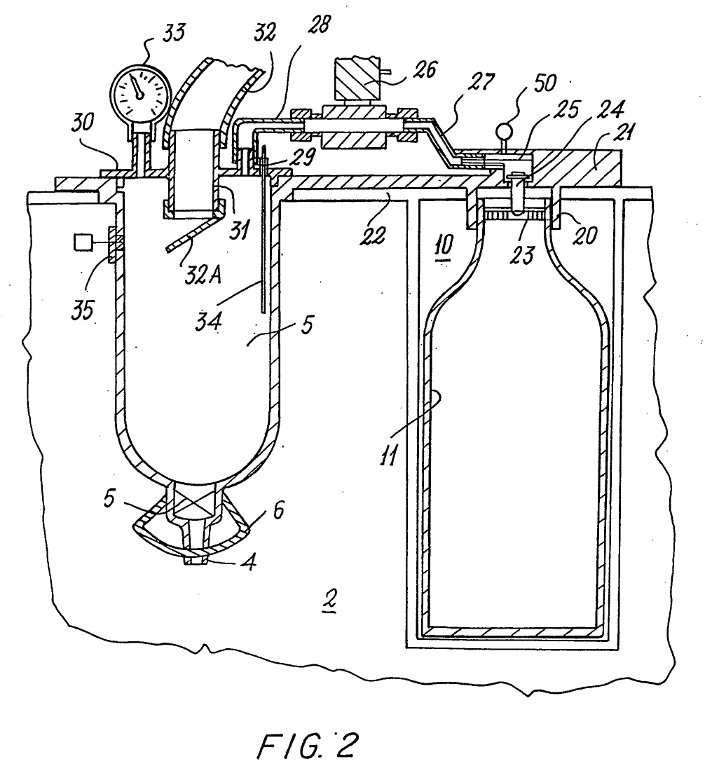

FIG. 2 is a more detailed view of the components involved in the dispensing of the water.

In the figures the reference numeral 1 indicates a refrigerator door, shown partially in vertical section. In the door there is provided a conventional compartment 2 open towards the outside and usable by the user to fill any container, for example a glass, with ice via a conventional dispenser for that purpose, or with cooled water which, according to the invention can be carbonated or still.

The water is dispensed via a nozzle 4 intercepted by a valve 5 conventionally operated by the user who for this purpose acts on a dispensing handgrip operationally connected to the valve.

The nozzle 4, valve 5 and handgrip 6 form a dispenser and are situated at the lower end of a water container, of given capacity, 7 mounted in a tubular seat 8, which extends into the compartment 2 and forms part of the lining of this compartment 2.

A chamber 10 of the compartment 2 (compartment to which access can be gained from the outside or from the inside of the door and which is closed by a shutter, not shown) removably houses a CO₂ cylinder, indicated by 11 and connectable to the container 7 to carbonate the water quantity contained therein, as described hereinafter with particular reference to FIG. 2.

This latter figure shows a more detailed construction of that already described. In FIG. 2 equal or corresponding parts carry the same reference numerals as already used.

The CO₂ cylinder is screwed or tightly pressed into a port 20 forming part of a support piece 21 fixed to the roof 22 of the compartment 2. The cylinder 11 is closed by a seal 23 which is perforated by a needle valve 24 mounted in the support piece 21 and located at the entry to a conduit 25 which extends into the support piece 21 and to which a solenoid valve 26 is connected via a pipe 27. The exit of the solenoid valve 21 is connected via a pipe 28 to an inlet port 29 present in a cover 30 fixed in any known manner to said support piece 21.

The cover 30 forms the sealing means for the water container 7 (which defines the carbonation environment) which, in this example, is integral with the support piece 21. The cover presents a nozzle 31 which passes through the cover, and at one end is connected to a conduit 32 for feeding water, for example tap water. At its other end the nozzle 31 is provided with a controlled valve 32A. A pressure gauge 33 can also be connected to the cover. The cover 30 also carries: a conventional level sensor 34 which extends into the container 7, and a safety (overpressure) valve 35 which acts on an electrical microswitch controlling a carbonated water indicator lamp (not visible) indicating that carbonation has taken place. Although not shown, there is also provided a pushbutton which by operating (in the sense of opening) the solenoid valve 26 connects the container 7 filled with water to the cylinder 11 for carbonating this water. Initially the container is empty. The level sensor 34 senses this situation and causes water to enter the container through the electrically operated valve 32A or alternatively through a solenoid valve, not shown, positioned in the conduit 32. The cooled still water is hence fed into the container 7. When a predetermined water level is reached, the level sensor 34 halts the feed of water (by acting on the valve 32A or on the alternative valve) and lights an indicator lamp which warns the user that the desired water level has been attained. The still water can however be withdrawn continuously even if the desired level has not been reached and the relative indicator lamp is not lit. Withdrawal is achieved in conventional manner by acting on the dispenser 4, 5, 6.

When the level indicator lamp is lit, the user can, if desired, initiate the carbonation phase by pressing a pushbutton (not shown) which activates the solenoid valve 26, enabling the CO₂ to flow from the cylinder 11 to the container 7 and to carbonate the water contained therein.

As already stated, the container 7 presents a safety and overpressure valve 35 provided with a electrical switch which when the required pressure has been attained in the container 7 closes the solenoid valve 26 and lights the indicator lamp to advise the user that the now carbonated water is ready to be drawn off.

In the case of operating anomalies, for example overpressure, the safety valve 35 opens to discharge the excess CO₂ into the atmosphere and at the same time closes the solenoid valve 26 to prevent the danger of explosion of the container 7.

The following advantages derive from the invention: the user no longer has to physically purchase large quantities of still or carbonated water, transport it and then store it in the home; this signifies a saving of time and fatigue; in addition empty bottles do not have to be retained for their recycling, there is less refuse and from an economical viewpoint there is a saving in the cost of the water, in addition to having it always available when required by the user.

The reference numeral 50 indicates a pressure sensor (pressure switch) which measures the pressure of the cylinder 11 and acts on an indicator lamp (not shown) to warn the user that the cylinder is empty.

1. A refrigerator incorporating (4, 5, 6) in its door (1) a water dispenser within a compartment (2) present on the outside of the door, characterised in that the dispenser is connected to a water container (7) of given capacity carried by the door and provided to enable the contained water to be carbonated via a connection to a cylinder (11) which contains the carbonating gas and is also located in the door (1).

2. A refrigerator as claimed in claim 1, wherein the cylinder (11) is disposed in a chamber (10) of the door (1), the chamber being accessible from the inside or from the outside of the door via a shutter.

3. A refrigerator as claimed in claim 1 or claims 1 and 2, wherein the cylinder (11) and the container (7) are connected together via a solenoid valve (26).

4. A refrigerator as claimed in claim 3, wherein the container (7) is provided with a water level sensor (34) which, when a given water level has been reached within the container, activates a means which indicates to the user that the water can now be carbonated by his operating the solenoid valve (26).

5. A refrigerator as claimed in one or more of the preceding claims, wherein the container (7) can be connected to the domestic water supply or to a possibly cooled source of water via a valve means (32A).

6. A refrigerator as claimed in one or more of the preceding claims, wherein the container (7) is provided with safety means (35) against excess pressure.

7. A refrigerator as claimed in one or more of the preceding claims, wherein in the connection between the cylinder (11) and container (7), upstream of the solenoid valve (26), a needle valve (24) is present cooperating with the cylinder (11).

8. A refrigerator as claimed in one or more of the preceding claims, wherein the safety valve (35) operates on an electrical switch to interrupt, at a predetermined carbonation pressure, the connection between the cylinder (11) and the container (7).

9. A refrigerator as claimed in claim 8, wherein said switch activates an indicator advising the user that the water is carbonated and ready to be drawn off.

10. A refrigerator as claimed in one or more of the preceding claims, wherein means connected to an indicator lamp are provided to indicate when the cylinder (11) is empty.
